(19) United States
(12) Patent Application Publication
(10) Pub. No.: US 2004/0128293 A1
(43) Pub. Date: Jul. 1, 2004

(54) Content delivery server and content delivery system having the same

(76) Inventor: Yukitoshi Maeda, Nara (JP)

Correspondence Address: Gerald Levy, Pitney Hardin Kipp & Szuch, 685 Third Avenue, New York, NY, 10017-4024, US

(21) Appl. No.: 10/363,710

(22) PCT Filed: Jul. 25, 2002
(86) PCT No.: PCT/JP02/07564

(30) Foreign Application Priority Data
Oct. 15, 2001 (JP) 2001-316545

(51) Int. Cl. G06F 17/30

(52) U.S. Cl. 707/10

(57) ABSTRACT

The apparatus offers a server for file distribution that can carry out playback of files attached to main files with certainty. The file distribution server includes a file data memory to store digital file data to distribute, which includes main file data and attached file data played back prior to main file data and digital file data in response to the request from user terminals. The management/playback program carries out the following processes: playing back distributed digital file data on the user terminal, controlling the prescribed operation in user terminal until playback of attached file data is completed.

### FIELD OF THE INVENTION

The present invention relates to a server for file distribution and file distribution system therewith. The server and the system are constructed to distribute various files to which public notice and similar information is added to user computers, which are connected to a communication network such as the Internet.

### BACKGROUND OF THE INVENTION

Recently the Internet has proliferated, and transactions using the Internet (online transactions) have increased. These online transactions are highly convenient because users need not to go to stores. In this regard, nowadays distribution systems for digital files (music, movies, software games, novels, etc.) are constructed on the Internet as web pages. Users can access the web pages with their computers, and download the digital files.

Since the above-mentioned distribution system can provide various files to many people, it can acquire an effective advertising result if the most appropriate public notice information for those who access the files is attached to each file.

For example, in official bulletin on Japanese Patent Publication No. 2001-256150, a device is disclosed to play back advertisement information while an enormous amount of file information is being downloaded, thus, utilizing time spent on it.

### DISCLOSURE OF THE INVENTION

However, since many of those who use this distribution system want access to necessary information when it is required, in many cases they play back only the main data files that they are interested in, without playing back added information such as advertisements, even if they are attached.

Therefore, in the bulletin on Japanese Patent Publication No. 2000-155741, a device is disclosed to the display advertisement information compulsorily on a part of the file information display.

Moreover in the bulletin on Japanese Patent Publication No. H10-155741, a device is disclosed to fill advertisement information in file information and change contents on fee collection or files to be played back in accordance with playback of advertisement information.

However, since in a device described in the bulletin on Japanese Patent Publication No. 2000-155741, if attached information such as advertisement information is always played back, it interferes with the appreciation of main file data and sometimes rather spoils the effect of the advertisement.

In addition, in the device described in the bulletin on Japanese Patent Publication No. H10-290443, a certain effect can be acquired on playback of advertisement information by changing the fee collection condition etc., but it is impossible to make those who do not want to play back attached information, such as an advertisement, to watch attached information with certainty, even if the fee collection condition is improved.

The present invention has been made in consideration of the above. The present invention relates to a server for file distribution and to a file distribution system therewith.

The server and the system make it possible to play back attached information such as advertisements etc. certainly prior to playback of main files, and to communicate contents of attached information to users.

The present invention, for attaining the above purpose is a server for file distribution connected to a user terminal through a communication network comprising: a file data memory having digital file data to be transmitted; a program memory having a computer program managing and playing back the digital file data; a management/playback program stored in the program memory requested from the user terminal; and a transfer processing unit transferring the digital file data stored in the file data memory; wherein said digital file data includes main file data and attached file data played back prior to main file data. The management/playback program performs a step of playing back the digital file data transferred from the file distribution server on the user terminal, and a step of controlling prescribed operation in the user terminal until playback of attached file data is completed.

According to this file distribution server, if a user terminal accesses the file distribution server via a communication network, and then the server receives requests for distribution of certain or user-selected digital files, the server transfers requested digital file data together with the management/playback program stored in the program memory to the user terminal that accessed the server. Then the management/playback program is suitably set up on the user terminal, and is ready to be started.

Moreover, in the case that the management/playback program has already been transferred and stored in the user terminal, one may transfer digital file data alone which is requested to be distributed to the user terminal.

In the user terminal, attached file data are played back first among file data transferred by the process of said management/playback program. On this occasion, the management/playback program controls the prescribed operation in the user terminal and makes it impossible to carry out an operation like fast-forward etc. during playback of attached file data. Then, when playback of prescribed attached file data is completed, it lifts the control, makes a normal operation possible, and starts playback of main file data.

As described in the above, according to this file distribution server, attached file data are played back prior to playback of requested main file data without fail. It is impossible to carry out operation of stop of playback in the user terminal. Therefore, if advertisement information etc. is used as attached file data, the stable effect of the advertisement can be expected.

Referring to attached file data, information which is wanted to be especially communicated to those who intend to watch main files such as education information and information related to the main file, in addition to advertisement information etc., are given as examples.

A further aspect of the present invention relates to a file distribution server wherein main file data and attached file data in the file distribution server are distinguished from each other by division code information. According to this file distribution server, simple control is possible because the only thing that the management/playback program should do until division code information emerges is to play back attached file data alone.

A still further aspect of the present invention relates to a file distribution server wherein main file data and attached file data in the file distribution server are distinguished from each other by header information. According to this file distribution server, in addition to the above-mentioned effect, the most appropriate environment for playback of attached file data can be prepared because information on attached file data can be acquired first.

A still further aspect of the present invention relates to a file distribution server wherein advertisement information is used as attached file data. According to this file distribution server, advertising can be done in the most effective means of file distribution using a communication network such as the Internet, so the effect of the present information can be obtained to the maximum extent.

A still further aspect of the present invention relates to a file distribution server wherein prescribed operation controlled in the user terminal is to stop the fast-forward function of attached files. According to this file distribution server, information contents can be communicated certainly even if advertisement information is used as attached files.

Thus, a file distribution server and a file distribution system, which consists of any one of the file distribution servers, and user terminals that are connected to each other via a communication network, can communicate attached file data certainly, and if advertisement information is used as attached file data, it becomes a system that can be expected to take a stable advertisement effect.

Note that the term digital file in this invention corresponds to digital information and data, such as characters, voices, and images, and computer programs. It includes digital music, movies, and novels, and also includes software games.

In addition, the term playback corresponds to the following: (1) outputting music sounds to the speakers of user terminals designed for digital music, (2) showing movies on the displays of user terminals designed for digital movies, (3) showing novels on the displays designed for digital novels, (4) making software games available on the user terminals designed for software games.

### BRIEF DESCRIPTION OF THE DRAWINGS

FIG. 1 is a block diagram showing the general structure of the file distribution system of one aspect of the present invention.

FIG. 2 is a block diagram showing the general structure of the file distribution server of one aspect of the present invention.

FIG. 3 is a flow chart to demonstrate the registration process at the user-registering module of one aspect of the present invention.

FIG. 4 is a diagram to illustrate the divide-and-spread process of the digital file data of one aspect of the present invention.

FIG. 5 is a flow chart to illustrate the distribution process at the transferring module of one aspect of the present invention.

FIG. 6 is a flow chart to show the playback process of one aspect of the present invention.

FIG. 7 is a flow chart to show the distribution process at the transferring module for another aspect of the present invention.

FIG. 8 is a flow chart to show the playback process for another aspect of the present invention.

FIG. 9 is a diagram to illustrate the outline of the data structure of the digital file data for one aspect of the present invention.

FIG. 10 is a diagram to illustrate the outline of the data structure of the digital file data for one aspect of the present invention.

FIG. 11 is a diagram to illustrate an example of the display of the user terminal for one aspect of the present invention.

### DETAILED DESCRIPTION OF THE PREFERRED EMBODIMENT

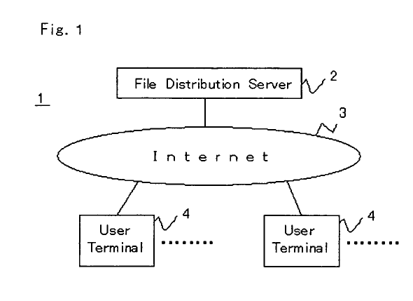

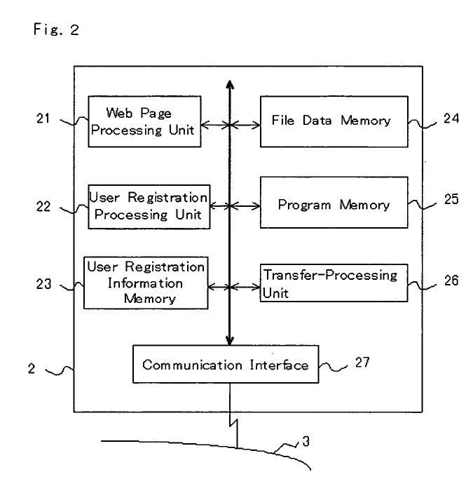

Details of one way of implementation for the present invention will be described below using attached figures. Now, FIG. 1 and FIG. 2 are block diagrams showing the general structures of the file distribution system and the file distribution server for the present embodiment respectively.

As shown in FIG. 1, the file distribution system 1 of this particular way of implementation is composed of file distribution server 2 and multiple user terminals 4, all of which are connected via the Internet 3. The file distribution server 2 functions as a server with CGI script and the Internet servers such as WWW servers. Each of the user terminals 4 functions as a client with browsers.

The file distribution server 2 is a computer with a CPU, ROM, RAM, and hard discs. As shown in FIG. 2, it has some function components such as a web page processing unit 21, a user-registration processing unit 22, a user-registration information memory 23, a contents data memory 24, a program memory 25, a transfer-processing unit 26, and a communication interface 27. The server is connected to the Internet 3 with the communication interface 27.

The web page processing unit 21 is a processing unit which opens up home pages on the Internet 3 for file distribution. Through these home pages, several processes are carried out such as user registration, transference of the management/playback program, and distribution of digital files.

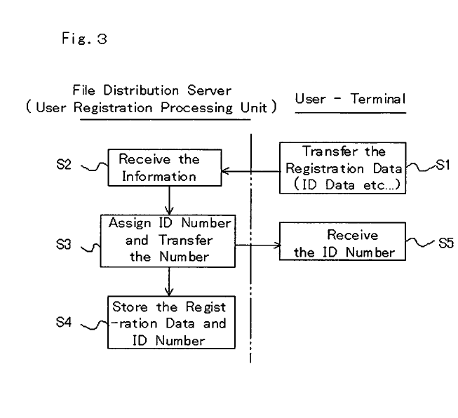

The user-registration processing unit 22 registers system-user information input from the user terminals 4 with the home pages. In detail, as shown in FIG. 3, when a user's registration information such as name, address, credit card number, e-mail address, password, etc, is input through the user terminal 4 (step S1), the user-registration processing unit 22 receives the information (step S2). Then the unit assigns an ID number to the user, and transfers it to the user terminal 4 (step S3). Each of the received user information and the assigned ID number is then stored in the user-registration information memory 23 (step S4). The screen of the user terminal 4 displays the transferred ID number (step S5) so that the user can see the number and perhaps, subsequently write it down.

The contents data memory 24 stores various digital file data such as information data including characters, voices, and images (novels, essays, music, movies, pictures, paintings, designs, etc), and computer programs (software games).

The program memory 25 stores a management/playback program and a cipher key, which are transferred to the user terminal 4, and are run or used in the terminal. The details of the management/playback program will be described later.

The transfer-processing unit 26 transfers the management/playback program etc., which are stored in the program memory 25, in response to the request from the user terminal 4. The unit also loads requested digital file data from the file data memory 24, and it transfers them to the user terminal 4.

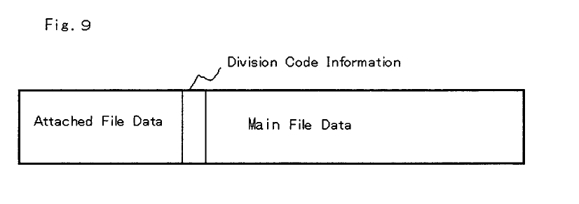

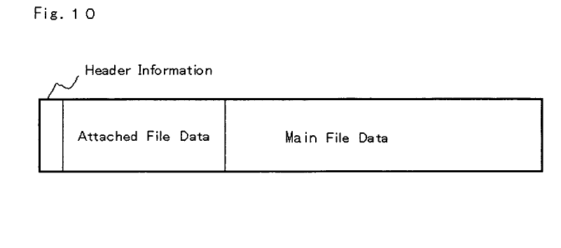

Additionally, the management/playback program is started on the user terminal 4 and carries out the following processes: (1) playing back the digital file data transferred from the transfer-processing unit 26, and (2) controlling prescribed operation in the user terminal until playback of attached file data included in digital file data is completed. More details of the digital file data structure and the management/playback program process will be explained below, using FIG. 9 and FIG. 10.

FIG. 9 and FIG. 10 show an example of the data structure of the digital file data. The digital file data includes main file data and attached file data. They are distinguished from each other by division code information in FIG. 9, by header information on attached file data or main file data in FIG. 10 respectively. They can be distinguished from each other by both header information and division code information.

The order of transfer of attached file information and main file information is not limited to the way shown in FIG. 9 and FIG. 10 when digital file data as a whole are stored in a user terminal at one time, although it might be necessary to be transferred in the order shown in the above figures in case of what is called streaming data (playback of file data is started before completion of reception of all the data).

When using the structure of digital file data as is shown in FIG. 9, the management/playback program carries out a process of controlling prescribed operations in the user terminal first, and then plays back attached file data. Referring to the process of controlling prescribed operation in the user terminal in this context, playback under the condition in which a part of its function is suspended such as prohibition of fast-forward playback and mute playback, and playback in special setup such as playback in amplified volume, image playback under emphasized effect (flash reverse etc.) are listed up as its example.

The term playback corresponds to the following: (1) outputting the music sounds to the speakers of user terminal 4 designed for digital music, (2) showing the movies on the displays of user terminal 4 designed for digital movies, (3) showing the novels on the displays designed for digital novels, and (4) making the software games available on the user terminal 4 designed for software games.

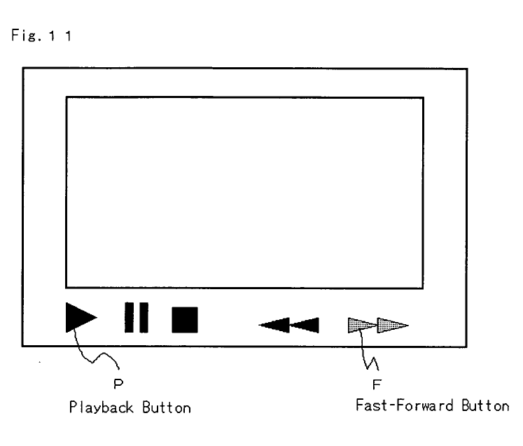

FIG. 11 is an example of the file playback display under the condition of prohibition of fast-forward playback. Playback button (P), fast-forward button (F), etc. are placed around the image display. As is shown in FIG. 11, such playback is carried out either by making the fast-forward button non-operational by making it a shadow display, or deleting the display of the fast-forward button itself etc.

Therefore, when the management/playback program reads the division code information, it makes it possible to carry out normal playback by lifting the control of the prescribed operation in said user terminal, and subsequently plays back the main file data.

Moreover, when the structure of digital file data of FIG. 10 is used, the management/playback program reads header information first, acquires information on time for playback of attached file data or main file data etc., and subsequently carries out the process of controlling the prescribed operation in the user terminal and plays back the attached file data. Therefore, it determines completion of attached file data from comparing built-in clock etc. of user terminal with information on the time for playback, makes it possible to carry out normal playback by lifting the process of controlling the prescribed operation in the user terminal after completion of playback of attached file data, and subsequently plays back main file data.

Furthermore, it is possible to adopt the most appropriate way for playback of attached file data by determining classification etc. of attached file data by header information.

Moreover, the management/playback program can restrict use of file information to a certain limit such as a rental period by being equipped with a function described as following steps.

That is, the management/playback program can be started on the user terminal 4 and carry out the following six processes: (1) making the storage space in the memory of user terminal 4 for digital file data to be transferred from the transfer-processing unit 26; (2) storing the transferred digital file data and deletion condition data into the storage space made in the previous process, after converting them into divided-and-spread data group according to a rule set in advance; (3) re-storing the converted file data to original digital file data, by re-converting the converted data stored in the memory according to the setting rule; (4) decrypting the restored digital file data; (5) playing back the decrypting digital file data on the user terminal 4; and (6) checking if the deletion conditions are fulfilled, and if they are fulfilled, the program deletes the converted file data stored in the memory.

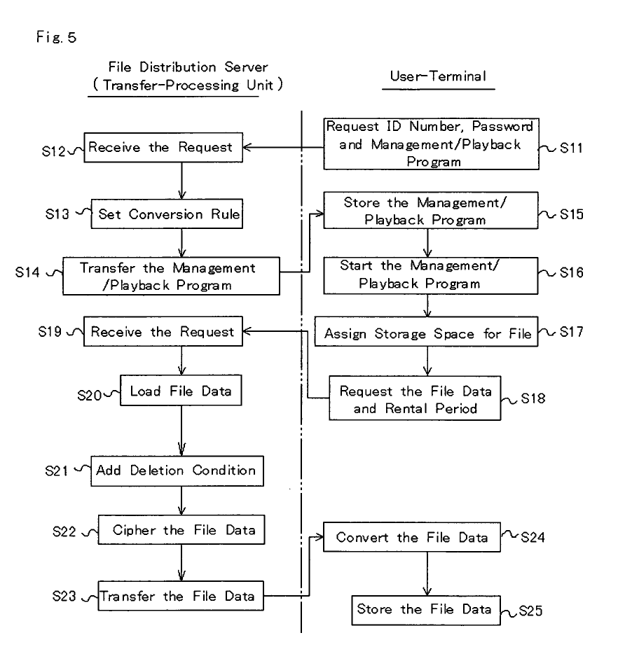

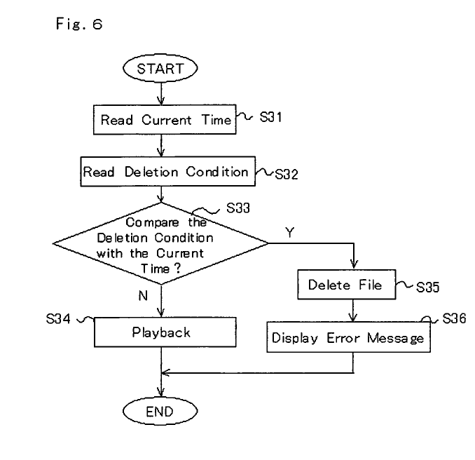

More details of the transfer-processing unit 26 and the management/playback program process will be explained below, using FIG. 5 and FIG. 6.

First, the distribution process of the files is described based on FIG. 5. As shown in FIG. 5, when a user terminal 4 inputs a request for transference of user information such as an ID number and a password or that of a management/playback program via web pages (step S11), the transfer-processing unit 26 receives the request (step S12). Then, the transfer-processing unit 26 loads the requested management/playback program and a cipher key from the program memory 25, and sets a conversion rule for divide-and-spread process of the digital contents. The conversion rule is unique to each one of its users' files (step S13). The set conversion rule data is transferred together with the management/playback program and the cipher key to the requesting user terminal 4 (step S14), and then they are stored in the user terminal 4 (step S15).

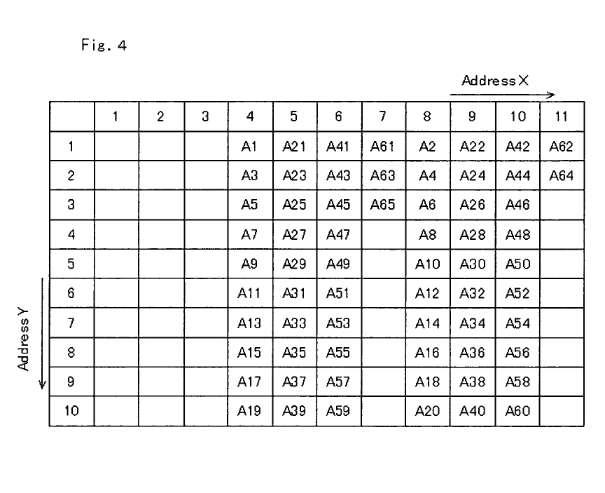

Next, when the transferred management/playback program is started on the user terminal 4 (step S16), this management/playback program makes storage space in the memory of the user terminal 4 for storing digital file data to be transferred from the file distribution server 2 (step S17). Specifically, as shown schematically in FIG. 4, the program sets two-dimensional storage space with addresses in vertical (Y) and horizontal (X) dimensions. The size of the storage space is adjusted according to the amount of data to be stored in the space.

After the setting of the storage space, the management/playback program enables the user terminal 4 to request a file from the file distribution server 2 (step S18). In other words, the program opens communication between the file distribution server 2 and the user terminal 4, and displays a file list, which is stored in the file data memory 24 of the file distribution server 2, on the screen of the user terminal 4. Then, the program makes it possible for the user to select desired files from the displayed list, or to enter the rental periods.

Then, after the necessary information (file to rent, rental period, etc) is fixed on the user terminal 4 (step S18), it is transferred to the file distribution server 2, and received by the transfer-processing unit 26 (step S19).

By receiving the input from the user terminal 4, the transfer-processing unit 26 loads requested digital file data from the file data memory 24 (step S20). Then, the transfer-processing unit 26 adds the deletion condition (the last day of the rental) to the loaded digital file data (step S21), and after ciphering the data, transfers them to the user terminal 4 (step S23). Now, considering the playback process that will be done later, it is desirable for the deletion condition to be a fixed-size data and to be inserted in the head of the digital file data. Thus, the present invention adopted this procedure.

After receiving the encrypted digital file data and the deletion condition that is added to it, the management/playback program run on the user terminal 4 converts the received data into the divided-and-spread data group according to the conversion rule (file data conversion, step S24). Then, the program stores the data into the storage space so as to make the data discontinuous partly or completely (step S25).

The specific way of the divide-and-spread process is as the following. First, the received data is sequentially divided into segments with predetermined size. Then, the divided data is stored in the memory with the address calculated by the formula,

X=P×á+â

where P is a constant assigned for and unique to each user, á is an integer that has the value form 1 to n, and â is an integer with the value from 0 to m. Also, n depends on horizontal size of the storage space, and m depends on P. In this case, the conversion rule is the formula, and the term “conversion to divided-and-spread data group” corresponds to the action of storing the digital file data into the storage space after dividing and spreading.

More specifically, the management/playback program sets the address of Y =1 and the value of á=0, and then it changes á sequentially from 1 to n. Using these values, the program calculated address X with the formula shown above, and stores divided data in the storage space corresponding to the calculated address (X, Y=1). Afterwards, changing the address Y from 2 to a fixed maximum value, and setting â=0 and changing â from 1 to n, the program calculates address X by changing â from 1 to m sequentially and iterating the same process. And then the program stores divided data sequentially in the derived address (X, Y).

FIG. 4 shows the way of storing the divided file data (A1-A65) in the address calculated above, by setting the maximum value of address X=11, that of address Y=10, P=4, á=1 to 2, and â=0 to 3. The divided file data is not stored in the space of address X=1 to 3.

In this way, the term “partly discontinuous” is defined as the state in which there are other data between the divided file data stored in X-directionally, if the direction of data reading is X-direction. Similarly, the term “completely discontinuous” is defined as the state in which other data are stored in all the spaces between each of the reading-directionally divided file data. The term “other data” in above definitions corresponds to other file data or any data other than file data. Regarding the case shown above, the divided file data would be completely discontinuous if â is set taking only odd or even numbers. In this way, digital file data and deletion condition data attached to it is distributed from the file distribution server 2 to the user terminal 4, and then the data is stored in the user terminal.

The process of playing back the digital file that is stored in the user terminal 4 is described below, based on FIG. 6. When the management/playback program is started on the user terminal 4, and selected to play back the digital file stored in the memory, the playback process in the program is carried out. As shown in FIG. 6, the program reads current time from a clock function in the user terminal 4 (step S31), and then it loads the deletion condition stored in the memory (step S32).

The deletion condition data is inserted at the head of digital file data, and stored in the memory together with the file data after divided and spread. Therefore, the process of loading the deletion condition data starts with calculating the address X, Y in which the deletion condition data is stored. The address is calculated according to the conversion rule (the above formula). Then the data is decrypted with the cipher key, which is transferred from the server 2 together with the management/playback program and stored in the user terminal 4.

Next, current time and the deletion condition data (the final day of the rental) is compared (step S33). If current time is before the final day of the rental, the selected digital files are played back (step S34). On the contrary, if the rental period is passed, the digital file data stored in the memory are deleted (step S35).

The playback includes three processes: (1) loading of the digital file data that is stored in the memory after dividing and spreading, (2) decrypting of the loaded digital file, (3) playing back of the decrypted digital file data. These processes can be carried out either in serial/parallel, or entirely in serial.

The loading process of the digital file data is done in the same way as the loading process of deletion condition data. That is, the addresses X and Y are calculated sequentially according to the conversion rule (the above formula), and the data stored in the address are loaded sequentially. This loading process is donated as a re-converting process. The deciphering process is done similarly based upon the cipher key, which is transferred with the management/playback program and stored in the user terminal 4. The playback process (step S34) ceases when the playback of the contents is completed.

The deletion process (step S35) is a process to overwrite a part or all of the digital file data with other data. The address X, Y of the digital file data is determined using the conversion rule (the above formula). After this process, the management/playback program shows error messages on the screen of the user terminal 4, and the messages notify users that the rental period is over, and that the contents were deleted (step S36). By this display of the error messages, the series of the deletion processes is completed.

As described above, in the file distribution system 1 in this case, the requested digital file data are divided according to the rules (conversion rule) set uniquely for each user, and then stored in the user terminal 4 discontinuously spread. In addition, without the management/playback program that has re-conversion function of digital files based on the rules uniquely set for each user, the distributed file cannot be played back. Therefore, even if transferred digital files (converted digital files) are copied, general playback programs cannot play back the copied files. In addition, because each management/playback program does not have compatibility with each other, users cannot play back digital file data that are distributed to other users. Furthermore, by converting file data into divided-and-spread data group, analyzing and restoring the data become highly difficult.

Therefore, by using the file distribution system 1 of this case, pirating of the transferred files becomes meaningless, and this fact makes it possible to prevent illegal usage of transferred files and piracy by illegal copying and the distribution of it.

In addition, the only management/playback program that is necessary to play back the files also carries out the deleting process of the distributed digital file. Therefore, when users run the program in an attempt to play back the digital file that is out of the rental period, the program surely deletes the invalid file. In this way, legal and proper rental can be done.

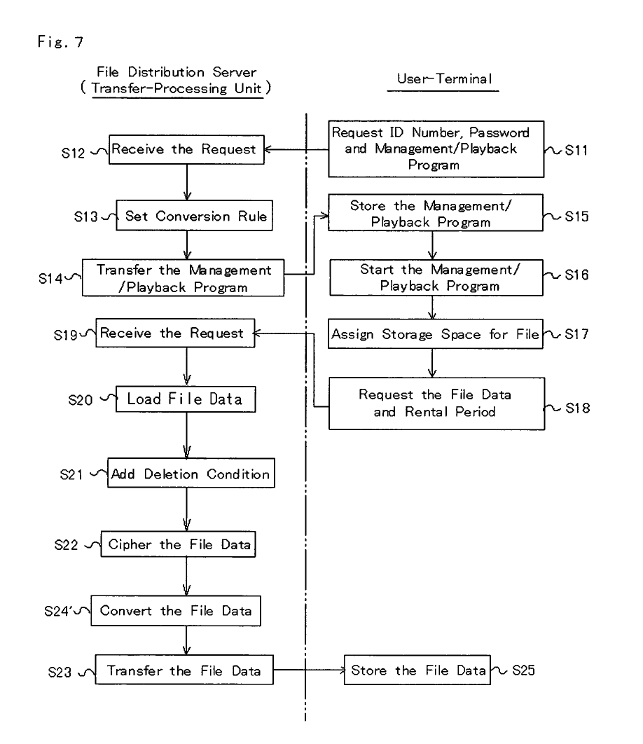

Although so far we explained an example of implementation for the present invention, specific ways of implementation that the present invention can carry out are not limited to the above description. For example, in the above description, the management/playback program that is run on user terminal 4 divides and spreads (converts) the distributed digital file, and stores it in the memory of user terminal 4. The implementation of the present invention, however, is not limited to the structure described above. As shown in FIG. 7, the divide-and-spread process (contents data conversion) can be done in the transfer-processing unit 26 (step 24′). The procedure of the divide-and-spread process can be the same one as described above.

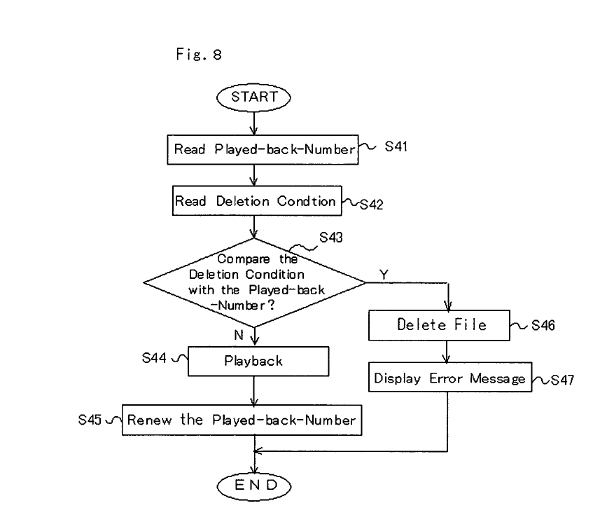

Additionally, though the deletion condition is defined as the final day of the rental period in the original explanation, it can be other conditions such as available repeating times of playback. In this case, played-back-number is stored in the memory of user terminal 4. In the playback process, as shown in FIG. 8, the stored played-back-number is read (step S41), and the deletion condition stored in memory is loaded in the same way as the original example (step S42). Then, the played-back-number and available repeat-number are compared (step S43).

If the played-back-number is less than the available repeat-number, the digital file data are played back (step S44), and the played-back-number is renewed (step S45). However, if the played-back-number is equal to the available repeat-number, the file is deleted (step S46), and error messages are shown (step S47). The deletion condition (available repeat-number) can be input in the step S18 shown in FIG. 5 and FIG. 7 in place of rental-period input.

Although deletion condition data in the original explanation is divided-and-spread as well as digital file data, it is possible to convert only digital file data.

In addition, the conversion rule unique to each user is not limited to the formula shown above. For example, the one with a random number is also effective.

Furthermore, although the original case is an example of a rental transaction, the selling transaction of the digital file data is also practical. In this case, the deleting process described above is not necessary.

In the case that the management/playback program with this function is used, the requested digital file data are stored in user terminals in the form of divided-and-spread data group, which are converted according to the setting rule. Therefore, without the management/playback program, which can re-convert file data by using the setting rule sent with the data, the transferred file cannot be played back.

Thus, even if transferred digital files (converted digital files) are copied, general playback programs cannot play back the copied files. In addition, by converting files data into divided-and-spread data group, analyzing and restoring the data become difficult.

Therefore, the system makes it possible to effectively prevent illegal use of transferred files and to prevent file piracy and distribution.

Moreover, if said setting rule in the file distribution server is unique to each one of its users, digital files transferred from digital file data cannot be played back without the management/playback program transferred to the user terminal when the file distribution server transfers the management/playback program to some user terminals because the setting rule (conversion rule) is unique to each one of its users and each management/playback program is not compatible with other management/playback programs. Therefore, the file distribution server makes it possible to prevent piracy by illegal copying of transferred digital files among users.

Furthermore, by the file distribution server, since digital file data to be transferred are transferred in ciphered condition, it is possible to more effectively prevent unjust usage of transferred digital files and piracy by illegal copying of transferred digital files among users.

In this way, with the file distribution server, attached file data are played back prior to playback of requested main file data without fail. It is impossible to stop playback of attached file data in the user terminal. Therefore, if advertisement information etc. is used as attached file data, a stable advertisement effect can be expected.

What is claimed is:

1. A server for file distribution connected to a user terminal through a communication network comprising:
a file data memory having digital file data to be transmitted;
a program memory having a computer program managing and playing back said digital file data;
a management/playback program stored in said program memory requested from said user terminal; and
a transfer processing unit transferring said digital file data stored in said file data memory;
wherein said digital file data consist of main file data and attached file data which are played back prior to attached file data;
wherein management/playback program performs a step of playing back said digital file data on said user terminal, and
a step of controlling the prescribed operation in the user terminal until playback of file data is completed.

2. The server for file distribution according to claim 1 wherein main file data and attached file data are distinguished from each other by division code information.

3. The server for file distribution according to claim 1 wherein main file data and attached file data are distinguished from each other by header information.

4. The server for file distribution according to any one of claims 1 to 3 wherein attached file data are advertisement information.

5. The server for file distribution according to any one of claims 1 to 3 wherein prescribed operation controlled in user terminal is to stop the function of fast-forward playback of attached files.

6. A server for file distribution system comprising:
a server for file distribution;
a user terminal connected through a communication network; wherein said server for file distribution is any server described in any of the above claims 1 to 3.
